(19) United States
(12) Patent Application Publication
(10) Pub. No.: US 2026/0339752 A1
(43) Pub. Date: Oct. 29, 2026

(54) LOAD DISTRIBUTION DEVICE, LOAD DISTRIBUTION SYSTEM, LOAD DISTRIBUTION METHOD, AND LOAD DISTRIBUTION PROGRAM

(71) Applicant: NTT, Inc., Tokyo (JP)

(72) Inventor: Yoshito ITO, Musashino-shi, Tokyo (JP)

(21) Appl. No.: 19/123,203

(22) PCT Filed: Oct. 26, 2022
(86) PCT No.: PCT/JP2022/039902

§ 371 Date: Apr. 22, 2025

(51) Int. Cl. G06F 9/50

(52) U.S. Cl. CPC G06F 9/5094; G06F 9/5083

(57) ABSTRACT

A distribution device (1) includes: an analysis data storage part (12) that stores, as ratio determination information for determining a distribution ratio for distributing received requests (9) among a plurality of servers (3), a quantity of received requests (9) to be allocated that maximizes the power efficiency, and a request distribution part (11) that determines, based on the ratio determination information read from the analysis data storage part (12), a distribution ratio for distributing the received requests (9) among the servers (3) such that the quantity of received requests (9) to be allocated that maximizes the power efficiency is assigned to each server (3).

### TECHNICAL FIELD

The present invention relates to a load distribution device, a load distribution system, a load distribution method, and a load distribution program.

### BACKGROUND ART

Various schemes have been proposed as a load distribution system for distributing received requests (or tasks) to any of a plurality of request processing parts (servers or CPUs).
Non-Patent Literature 1 describes the following two schemes as load balancers for distributing requests.
Static distribution scheme: Round Robin (RR), which is a representative policy, (statically) selects distribution destinations in order in a predetermined ratio.
Dynamic distribution scheme: A distribution ratio is dynamically changed for execution based on information such as the number of connections of distribution destinations, the number of clients, an amount of data communication, and a CPU use rate.

Non-Patent Literature 2 proposes Peak Efficiency Aware Scheduling (PEAS) having the following components.
Local Energy Efficiency Profiler (LEEP) dynamically measures the power efficiency of each server.
Global Scheduler, based on the power efficiencies acquired from LEEP, distributes requests to servers in order from the server with the highest power efficiency up to a resource use rate corresponding to the maximum efficiency (maximum power efficiency) of the server.

Non-Patent Literature 3 proposes Per Application Class Turbo Controller (PACT), which reduces power consumption even in a data center with a high use rate using the following two components. Note that App priority class (Per Application Class) is “latency sensitive” or “best-effort”.
“CPU Jailing” creates a CPU core allocation group and assumes that it operates with a low power consumption setting in “best-effort”.
“Turbo Control” dynamically executes V/F control and allocates more CPU cores to “latency sensitive” as a countermeasure to burst.

### PRIOR ART LITERATURE

### Non-Patent Literature

[Non-Patent Literature 1] Fujitsu, “Introduction to load distribution—3rd request distribution function (1/2),” [online], [Retrieved Oct. 18, 2022], 2006.12.19, Internet<URL: https://www.fujitsu.com/jp/products/network/security-bandwidth-control-load-balancer/ipcom/material/data/1/3.html>
[Non-Patent Literature 2] D. Wong, “Peak Efficiency Aware Scheduling for Highly Energy Proportional Servers,” [online], [Retrieved Oct. 18, 2022], 2016 ACM/IEEE 43rd Annual International Symposium on Computer Architecture (ISCA), 2016, pp. 481-492, doi: 10.1109/ISCA.2016.49, Internet<URL: https://ieeexplore.ieee.org/document/7551416>
[Non-Patent Literature 3] Kostis Kaffes, Dragos Sbirlea, Yiyan Lin, David Lo, and Christos Kozyrakis, “Leveraging application classes to save power in highly-utilized data centers,” [online], [Retrieved Oct. 18, 2022], In Proceedings of the 11th ACM Symposium on Cloud Computing (SoCC '20). Association for Computing Machinery, New York, NY, USA, 134-149, Internet<URL: https://doi.org/10.1145/3419111.3421274>

### SUMMARY OF THE INVENTION

### Problems to be Solved by the Invention

The conventional arts as Non-Patent Literatures 1 to 3 are not capable of executing request distribution such that the resource utilization rate of a request processing parts is maintained constant and thus not capable of maintaining the request processing part in a state where maximum efficiency is achieved. Therefore, the conventional arts perform the processing in an inefficient resource use rate range, resulting in an increase in the power consumption.

In view of this, a main object of the present invention is to cause a request processing part to operate so as to improve the power efficiency.

### Solution to Problem

In order to solve the problem, a load distribution device of the present invention has the following features.
The present invention includes:
an information storage part that stores, as ratio determination information for determining a distribution ratio for distributing requests among a plurality of request processing parts, a quantity of requests to be allocated that maximizes power efficiency; and
a distribution part that determines, based on the ratio determination information read from the information storage part, a distribution ratio for distributing the requests among the request processing parts such that the quantity of requests to be allocated that maximizes the power efficiency is assigned to each request processing part.

### Advantageous Effects of Invention

According to the present invention, it is possible to cause the request processing part so as to increase the power efficiency.

### BRIEF DESCRIPTION OF THE DRAWINGS

FIG. 1 is a configuration diagram of a load distribution system related to the present embodiment.

FIG. 2 is a detailed configuration diagram of the load distribution system related to the present embodiment.

FIG. 3 is a hardware configuration diagram of each device of the load distribution system related to the present embodiment.

FIG. 4 is a table showing the content stored in a collected data storage part related to the present embodiment.

FIG. 5 is a flowchart illustrating the processing of a data collecting part related to the present embodiment.

FIG. 6 is a flowchart illustrating the processing of a data analysis part related to the present embodiment.

FIG. 7 is a graph showing relationships of power characteristic information related to the present embodiment.

FIG. 8 is a flowchart illustrating the processing of a request distribution part related to the present embodiment.

FIG. 9 is an explanatory diagram showing the assigned proportion for each server related to the present embodiment.

FIG. 10 illustrates a table showing processing for updating the distribution ratio for the table of FIG. 4 related to the present embodiment.

FIG. 11 is an explanatory diagram showing an example in which the distribution ratio updated in FIG. 10 is applied to the explanatory diagram of FIG. 9 related to the present embodiment.

### MODES FOR CARRYING OUT THE INVENTION

Hereinafter, an embodiment of the present invention will be described in detail with reference to the drawings.

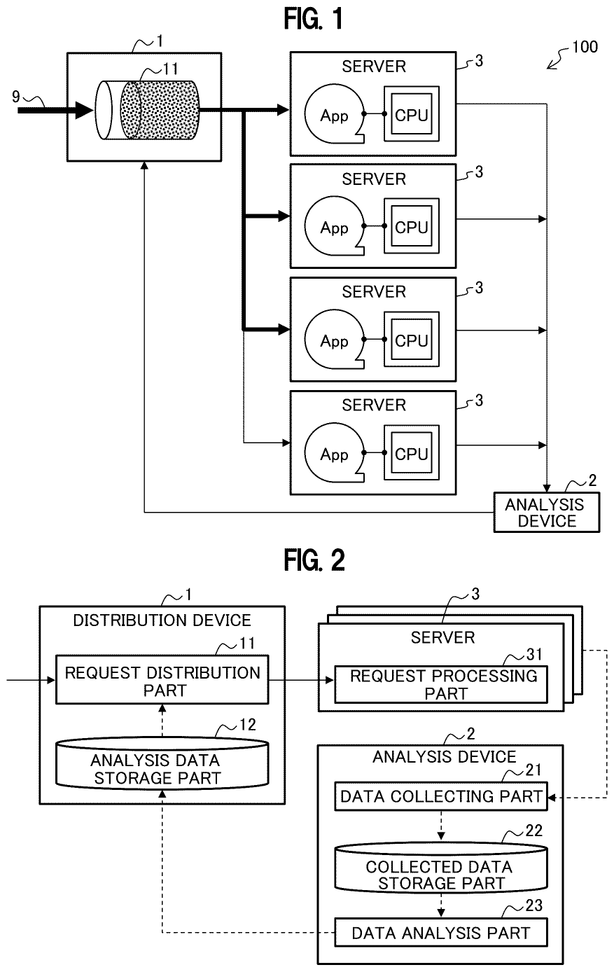

FIG. 1 is a configuration diagram of a load distribution system 100.
The load distribution system 100 includes a distribution device (load distribution device) 1, an analysis device 2, and servers 3, which are connected via a network.
The distribution device 1 distributes received requests (or tasks; hereinafter referred to as “received requests 9”) among the servers 3. The received requests 9 are stored in a queue of a request distribution part 11, and sequentially read from the queue and distributed to the servers 3. As the distribution device 1 dynamically controls the ratio for distributing the requests, the distribution device 1 can be configured with less implementation through extension based on the function of an existing Layer 4 (L4) load balancer.

The analysis device 2 collects from each server 3 information to be used by the distribution device 1 to determine the ratio for distributing the requests, and analyzes the information. For example, the analysis device 2 analyzes power characteristic information of each server 3 and notifies the distribution device 1 of the analysis result. On the other hand, as the distribution device 1 is able to determine the ratio for distributing the requests based on the information communicated from the analysis device 2, the distribution device 1 need not directly monitor the resource use rate per server 3. Therefore, the distribution device 1 has a small overhead through simple distribution processing.

The servers 3 are distribution destinations of the requests from the distribution device 1. The server 3 includes a CPU for processing its distributed requests and an application (App) operating on the CPU. In FIG. 1, four Web servers are operating as the distribution destination servers 3, and each Web server processes HTTP requests allocated by the distribution device 1.
Hereinafter, an expression “requests are distributed to the server 3” means, more accurately, that the requests are distributed to request processing parts 31 (FIG. 2) in the servers 3. Further, the resource (for example, CPU) of the server 3 means a resource used for an operation of the request processing part 31 in the server 3. Hereinafter, for the sake of simplicity of description, an exemplary configuration in which one CPU is present in one server 3 is presented. However, the present embodiment is also applicable to a configuration in which a plurality of request processing parts 31 (a plurality of CPUs) are present in one server 3.

The distribution device 1 can be applied to, for example, the following devices.
A (L4 or L7) load balancer, which is a distribution device 1, determines the ratio for distribution to Web servers based on a request arrival rate (Requests Per Second (RPS) or the like) of the received requests 9 (HTTP requests) (details will be described later in the present specification).
A Layer 2 switch (L2SW), which is a distribution device 1, determines the ratio for distribution to CPUs or processing circuits based on a packet arrival rate of the received packets.
A (L4 or L7) load balancer, which is a distribution device 1, is deployed among the servers 3 and determines the ratio for distribution to Packet Data Network Gateways (P-GW) based on the packet arrival rate of the received packets.
A task scheduler, which is a distribution device 1, is deployed in a server 3 and determines the ratio for distribution to CPUs or processing circuits based on the packet arrival rate of the received packets.

As comparative examples, two types of schedulers below have been implemented in the kernel of conventional Linux (registered trademark).
Standard scheduler: Stop-Task, Deadline-Task, Realtime-Task, Fair-Task, Idle-Task.

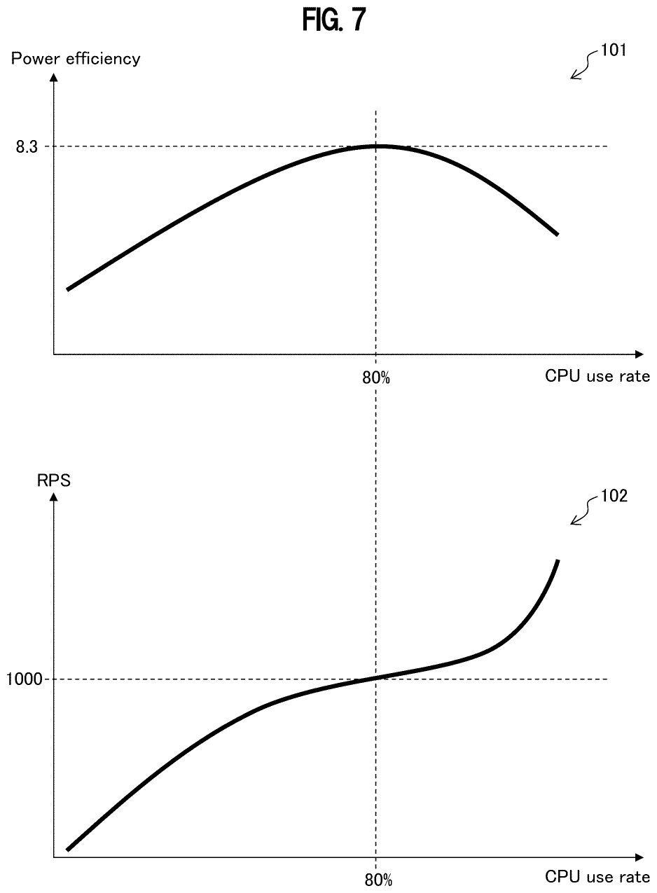

This standard scheduler performs task execution control according to priority.
Arm (registered trademark) specialized scheduler: Capacity Aware, Power Aware. This Arm-specialized scheduler performs task execution control assuming a heterogeneous physical core configuration (for example, big. LITTLE).
However, as any comparative example fails to take into account the power efficiency, it fails to cause an operation to operate at an operation point optimal with respect to the resource use rate. The Arm-specialized Power Aware scheduler is intended to keep the CPU frequency to a lowest frequency on the premise of big. LITTLE and fails to take the power efficiency into account.
In view of this, a task scheduler acting as the distribution device 1 of the present embodiment constitutes the request distribution part 11 such that an operation is performed at an operation point optimal with respect to the resource use rate (see FIG. 7 for details).

FIG. 2 is a detailed configuration diagram of the load distribution system 100.
The server 3 includes the request processing part 31. Note that the analysis device 2 and the server 3 may be configured as separate devices or may be included in the same device.
The request processing part 31 processes received requests 9 allocated by the distribution device 1.

The analysis device 2 includes a data collecting part 21, a collected data storage part 22, and a data analysis part 23.
The data collecting part 21 collects per-server 3 power characteristic information before or during request processing of the server 3, and stores the result of collection in the collected data storage part 22. The power characteristic information is, for example, data of power efficiency with respect to the resource use rate of the request processing part 31 (see FIG. 4 for details).
The data analysis part 23 analyzes the power characteristics of each server 3 based on the power characteristic information read from the collected data storage part 22 and notifies the distribution device 1 of the analysis result as ratio determination information (information for determining the distribution ratio). The ratio determination information includes a resource use rate (CPU use rate or the like) that maximizes the power efficiency and a request arrival rate (RPS or the like) that results in that resource use rate.

The distribution device 1 includes the request distribution part (distribution part) 11 and an analysis data storage part (information storage part) 12. Note that the analysis data storage part 12 may be configured to be located outside the distribution device 1 and accessible via a network.
The analysis data storage part 12 stores the ratio determination information communicated from the data analysis part 23 of the analysis device 2 as analysis data of the data analysis part 23.
The request distribution part 11 determines a distribution ratio for distributing the received requests 9 among the servers 3 based on the ratio determination information read from the analysis data storage part 12. For the distribution ratio, a consideration is made as to how the highest power efficiency is achieved by distributing the requests to which resource at which proportion with respect to the request arrival rate. The request distribution part 11 distributes the requests among the servers according to the distribution ratio.

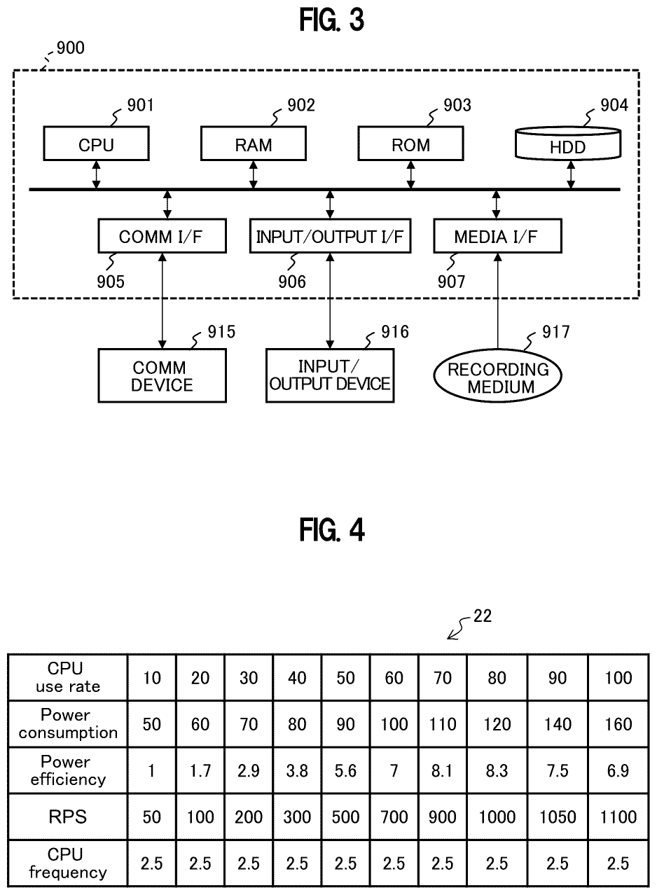

FIG. 3 is a hardware configuration diagram of each device of the load distribution system 100.
Each device (distribution device 1, analysis device 2, or server 3) of the load distribution system 100 is configured as a computer 900 including a CPU 901, a RAM 902, a ROM 903, an HDD 904, a communication I/F 905, an input/output I/F 906, and a media I/F 907.
The communication I/F 905 is connected to an external communication device 915. The input/output I/F 906 is connected to an input/output device 916. The media I/F 907 reads and writes data from and to a recording medium 917. Furthermore, the CPU 901 controls each component by executing a program (also referred to as an application or app as an abbreviation therefor) read into the RAM 902. This program can also be distributed through a communication line or recorded on the recording medium 917 such as a CD-ROM to be delivered.

FIG. 4 is a table showing the content stored in the collected data storage part 22.
The table in FIG. 4 stores: a CPU use rate (%), which is a resource use rate of the server 3; a power consumption (W) of the server 3; a power efficiency (Request/W) of the server 3; requests per second (RPS; the number of processed requests/sec), which is a processing amount of the server 3; and a CPU frequency (GHz) of the server 3, associated with one another.
The power efficiency of the server 3 is the number of requests that can be processed per 1 W (Watt) and, generally, is processing performance per power consumption. The CPU frequency of the server 3 is an operation frequency.

Hereinafter, description will be given on the assumption that processing of any request has substantially the same load amount and it is not necessary to distinguish between the requests. On the other hand, the requests may be classified into, for example, any of: a request with a high load, a request with a medium load, and a request with a small load, as a request type, and the number of requests may be counted for each request type.
Furthermore, as shown in the table of FIG. 4, since the power consumption of the server is generally non-linear with respect to the CPU use rate, the power efficiency of the execution of the request does not simply increase with respect to the CPU use rate.
The data collecting part 21 collects the information in the table shown in FIG. 4 as the per-server 3 power characteristic information. Here, the table in FIG. 4 is completed with only one table in a configuration (homogeneous configuration) in which a plurality of servers 3 have the same processing performance. On the other hand, in a configuration (heterogeneous configuration) in which the plurality of servers 3 have different processing performances, it is necessary to prepare a table for each server 3.

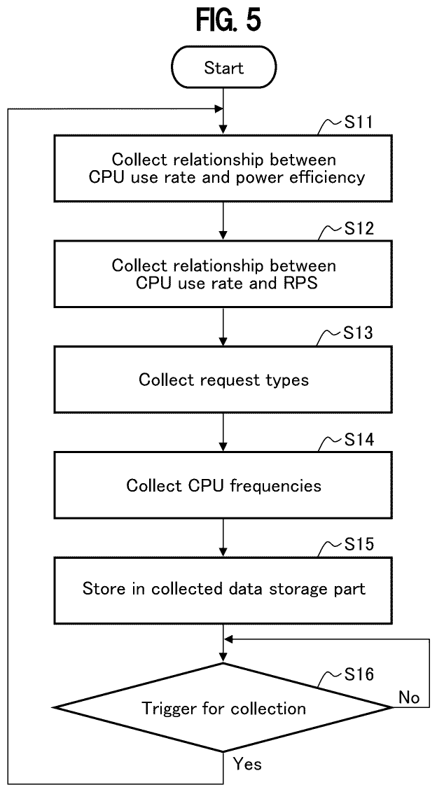

FIG. 5 is a flowchart illustrating the processing of the data collecting part 21.
The data collecting part 21 collects (S11) the relationship between the CPU use rate and the power efficiency for each server 3. Collection processing of S11 is performed in the following procedure, for example, by using a load tool or actual requests.
(Procedure 1) Requests are transmitted to each server 3 in a range of 0% to 100% of CPU use rate by using a load tool, and data of the number of requests processed is collected based on a log of the Web server and data of power consumption is collected with an Intelligent Platform Management Interface (IPMI) or a power meter.
(Procedure 2) Information on the correspondence between the number of requests processable per 1 W and the CPU use rate, collected in procedure 1, is stored as correspondence information between “CPU use rate” and “power efficiency” in the table of FIG. 4. With this, the resource use rate for maximum efficiency can be calculated and can be applied also to a heterogeneous configuration.
For the resource use rate collected in S11, not only the CPU use rate, but also many resource use rates such as a Graphics Processing Unit (GPU) use rate and a memory use rate can be handled in a multi-dimensional manner.

The data collecting part 21 collects (S12) relationship between the CPU use rate and the RPS by using the data collected in S11. The information collected in S12 is stored as correspondence information between the “CPU use rate” and the “RPS” in the table of FIG. 4. With this, as the resource use rate is not required for the distribution logic of the request distribution part 11, it is not necessary to monitor the resource use rate of a distribution destination server 3.
The data collecting part 21 may collect (S13) data for each request type for the collection processing of S11 and S12. In this case, the table of FIG. 4 is generated for each combination of the number of servers 3 and the number of request types. That is, the data collecting part 21 classifies the number of requests processed by each server 3 into any of a plurality of request types and collects the power characteristic information of each server 3 for each request type.

Further, the data collecting part 21 may, when collecting data in S11, also collect (S14) a CPU frequency (operation frequency of the resource) of each server 3 and store the data and the CPU frequency associated with each other in the table of FIG. 4.
The data collecting part 21 associates the pieces of information collected in S11 to S14 and stores (S15) the information in the collected data storage part 22 as the power characteristic information for each server 3 shown in FIG. 4. The collected data storage part 22 is a database accessible from the distribution device 1.

The data collecting part 21 waits (S16: No) until a next trigger of data collection processing, and starts the processing of S11 again when the data collection processing is triggered (S16: Yes). Examples of the trigger of the data collection processing include any of the following. With this, it is possible to update the data stored in the collected data storage part 22 following changes in the power efficiency.
Regular execution: The processing of S11 starts every preset time interval (for example, one week).
Detection of change in power efficiency: For example, as setting information of the server 3 and environment information (temperature change or the like) around the server 3, a power policy, C-state, HyperThreading, fan control, power cap, and thermal throttling are collected. Then, when a change occurs from the information collected in the past, the processing of S11 is started.
As described above with reference to FIG. 5, the data collecting part 21 collects, for each server 3, power characteristic information indicative of power efficiency with respect to the number of requests, based on the number of requests processed by the server 3 and the power consumption required for processing the requests.

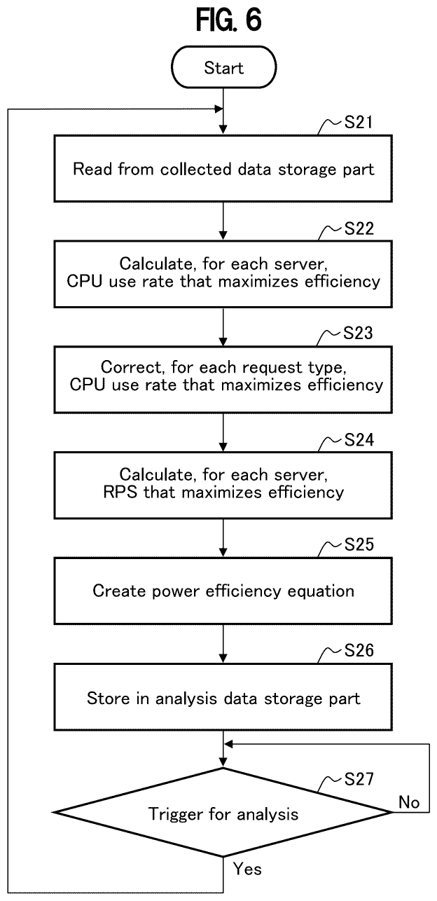

FIG. 6 is a flowchart illustrating the processing of the data analysis part 23.
The data analysis part 23 reads (S21) the power characteristic information collected by the processing of FIG. 5 from the collected data storage part 22.
The data analysis part 23 calculates (S22; details are shown in FIG. 7), for each server 3, a CPU use rate that maximizes efficiency by using the power characteristic information read in S21.
When data are collected for each request type in S13, the data analysis part 23 may correct (S23) the calculation result of S22 for each combination of the server 3 and the request type. That is, the data analysis part 23 may, based on the power characteristic information of each server 3 collected for each request type, obtain a quantity of received requests 9 to be allocated that maximizes the power efficiency for each request type and store the obtained result in the analysis data storage part 12 as the ratio determination information.

The data analysis part 23 determines (S24; details are shown in FIG. 7), for each server 3, an RPS which results in a maximum efficiency based on the CPU use rate which maximizes the efficiency of the server 3. With this, as real-time metrics such as a CPU use rate for each server 3 are not required for the ratio determination information, it is possible to simplify the processing of determining the distribution ratio to avoid unnecessary power consumption due to collection of the metrics.
Furthermore, the data analysis part 23 may formulate a relationship between the RPS and the power efficiency by using an approximate equation or the like by using regression analysis or the like for the power characteristic information read in S21, to create (S25) a power efficiency equation indicating power efficiency with respect to the number of requests as illustrated below. With this, it is possible to set an operation point at which the power efficiency is increased as much as possible even for a server 3 operating at a CPU use rate that does not maximize efficiency.

y=−1E−08x³+9E−06x²+0.008x+1.0731

### (x Represents Rps, and Y Represents Power Efficiency)

The data analysis part 23 transmits a per-server 3 RPS (calculation result of S24) that maximizes efficiency and the created power efficiency equation (calculation result of S25) to the distribution device 1 as the ratio determination information, to cause (S26) the analysis data storage part 12 in the distribution device 1 to store the ratio determination information.
The data analysis part 23 waits (S27: No) until the next trigger of data analysis processing and starts the processing of S21 again when the data analysis processing is triggered (S27: Yes). Examples of the trigger of the data analysis processing includes when the per-server 3 power characteristic information stored in the collected data storage part 22 is updated due to data collection processing being triggered (S16: Yes).
As described above with reference to FIG. 6, the data analysis part 23, based on the collected power characteristic information of each server 3, obtains a quantity of received requests 9 to be allocated that maximizes the power efficiency and causes the analysis data storage part 12 to store the obtained result as the ratio determination information.

FIG. 7 is a graph showing a relationship of the power characteristic information.
The first graph 101 and the second graph 102 are generated from the power characteristic information in the collected data storage part 22 shown in FIG. 4 or the like.
In the first graph 101, the horizontal axis represents the CPU use rate and the vertical axis represents the corresponding power efficiency. The data analysis part 23 obtains a peak value=8.3 of the power efficiency of the first graph 101 and calculates (S22) a CPU use rate=80% corresponding to the peak value as the CPU use rate that maximizes efficiency.
In the second graph 102, the horizontal axis represents the CPU use rate, and the vertical axis represents the corresponding RPS. The data analysis part 23 determines (S24) an RPS=1000 corresponding to the CPU use rate=80% obtained from the first graph 101 in S22 as an RPS which results in a per-server 3 maximum efficiency. In this way, the data analysis part 23 creates ratio determination information such that a specific CPU use rate=80% is maintained. On the other hand, in the distribution scheme described in Non-Patent Literature 1, distribution is merely to be preferentially performed to a server with a low CPU use rate.

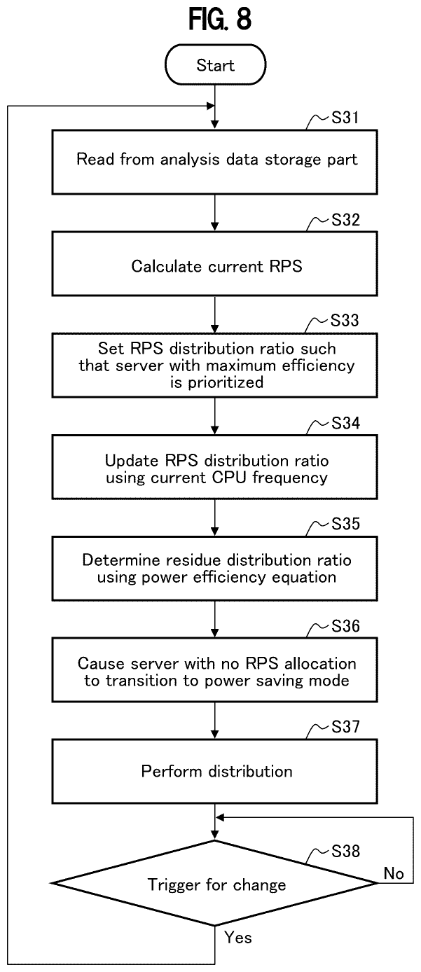

FIG. 8 is a flowchart illustrating processing of the request distribution part 11.
The request distribution part 11 reads (S31) the ratio determination information stored in S26 from the analysis data storage part 12. The analysis data storage part 12 stores, as the ratio determination information for determining the distribution ratio when distributing the received requests 9 among the plurality of servers 3, a quantity of received requests 9 to be allocated that maximizes the power efficiency.
The request distribution part 11 calculates (S32) a current RPS from the number of HTTP requests per second of the received requests 9.

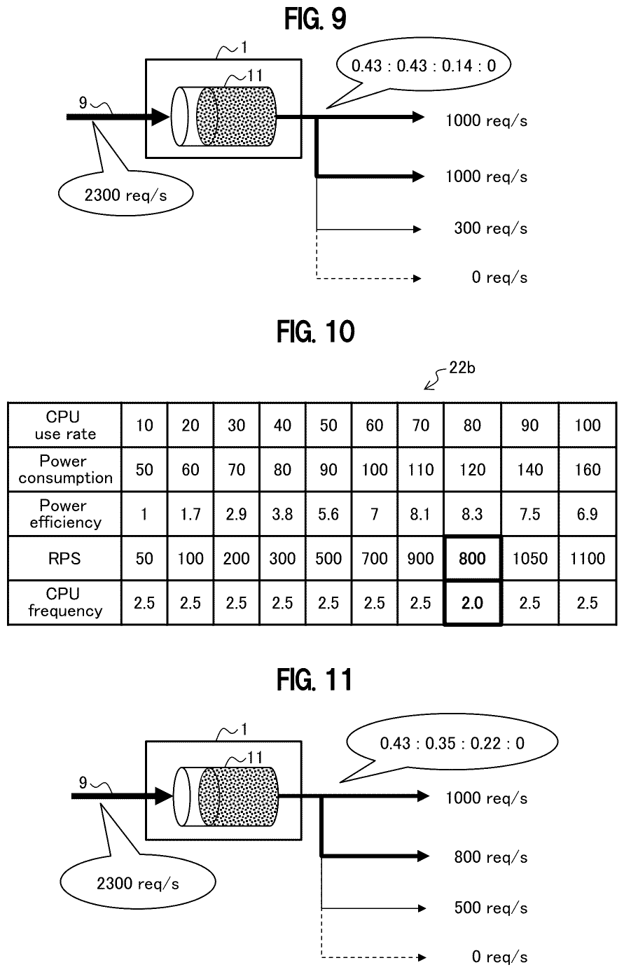

The request distribution part 11 references the ratio determination information to set (S33; details are shown in FIG. 9) a distribution ratio of the current RPS, such that a server 3 to which an RPS maximizing efficiency can be allocated is prioritized. That is, in S33, the request distribution part 11 determines, based on the ratio determination information read from the analysis data storage part 12, a distribution ratio for distributing the received requests 9 among the servers 3 such that the quantity of received requests 9 to be allocated that maximizes the power efficiency is assigned to each server 3.

Furthermore, the request distribution part 11 may update (S34) the RPS distribution ratio in S33 by using the current CPU frequency. An example of the update processing in S34 is to, with respect to the distribution ratio set in S33, update the distribution ratio using the current CPU frequency on the assumption that the processable RPS increases in proportion to the CPU frequency. In this way, it is possible to minimize the influence due to an operating environment by considering a correction according to the operation frequency of a resource.
That is, the request distribution part 11 may, based on the current operation frequency of each server 3, correct the quantity of received requests 9 to be allocated that maximizes the power efficiency and determine the distribution ratio for distributing the received requests 9 among the servers 3 based on the corrected quantity of received requests 9 to be allocated.

The request distribution part 11 determines the ratio of distributing the remaining RPS by using the power efficiency equation for ratio determination information (S35; details are shown in FIG. 9). The remaining RPS is a result of subtracting from the current RPS in S32 the RPS distributed to the servers 3 to which an RPS maximizing efficiency can be allocated in S33. This makes it possible to improve power efficiency by distributing even the remaining RPS which have not been distributed in S33 so that the power efficiency is increased as much as possible in S35.
That is, the request distribution part 11 determines, for the received requests 9 that have remained due to a failure of distributing the quantity of received requests 9 to be allocated that maximizes the power efficiency to any of the servers 3, one or more distribution destination servers 3 so that the power efficiency is increased according to the power efficiency equation.

Further, the request distribution part 11 may cause the servers 3 to which no RPS is allocated until S35 to transition (S36) to the power saving mode (for example, power OFF, Sleep). That is, the request distribution part 11 may, when determining the distribution ratio for distributing the received requests 9 among the servers 3, cause the servers 3 to which no received request 9 has been allocated to transition to the power saving mode. This makes it possible to improve the power efficiency of the entire system.

The request distribution part 11 executes (S37) processing for distributing the received requests 9 among the request processing parts 31 of the servers 3 according to the RPS distribution ratio determined until S35. With this, as the request distribution part 11 does not need to individually determine a distribution destination for each request while executing the distribution and can be implemented based only on a distribution logic with a simple distribution ratio, an overhead of the distribution is small.

The request distribution part 11 waits (S38: No) until the next trigger of changing the distribution ratio and starts processing of S31 when a change of the distribution ratio is triggered (S38: Yes). Examples of the trigger of changing the distribution ratio includes any of the following.
When the current RPS (S32) of the received requests 9 has been changed.
When the ratio determination information stored in the analysis data storage part 12 is updated by the data analysis processing being triggered (S27: Yes).

In this way, the request distribution part 11 operates as a dynamic distribution scheme according to the triggers of changing the distribution ratio, and each server 3 always operates at a resource use rate maximizing efficiency while the current RPS (S32) and the ratio determination information are constant. Thus, the load distribution system 100 is capable of operating in a state where the power efficiency of the entire system is high.

FIG. 9 is an explanatory diagram showing an example of a distribution ratio for servers.
The request distribution part 11 calculates (S32) a current RPS=2300 [req/s] of the received requests 9.
The request distribution part 11 references from the ratio determination information an RPS=1000 which results in a maximum efficiency of each server 3, to calculate that two servers among the current RPS=2300 can be operated with the maximum efficiencies (1000×2=2000) and the remaining RPS=300 cannot be operated with the maximum efficiency. Therefore, an RPS=1000, which maximizes efficiency, is distributed to two servers 3 from the top of FIG. 9 among the four servers 3.

In the present example, description has been given of a case in which an RPS (RPS=1000) maximizing efficiency to an efficiency of 8.3 is the same among the four servers. On the other hand, when the maximum efficiency is different among a plurality of servers, it is preferable to sort the servers in descending order of the maximum efficiency and to assign an RPS that maximizes efficiency preferentially to the sorted servers (in descending order of the maximum efficiency). With this, for a plurality of servers 3 having different power characteristic information, more RPS are allocated to a server 3 with higher power efficiency, so that the power efficiency of the entire system can be maximized.
The request distribution part 11 sets (S33), for each server 3, “RPS distributed to the server 3”/“current RPS”=an assigned proportion of current RPS. For example, in FIG. 9, an assigned proportion of 1000/2300=0.43 is set to the server 3 located first from the top.

The request distribution part 11 determines (S35) a ratio of distributing the remaining RPS (=300)=“RPS to be allocated to the remaining servers 3”/“current RPS” by using the power efficiency equation of the ratio determination information. For example, among the following two candidates in which distribution is to be made to the remaining servers 3 of the third and fourth servers, Candidate 1, in which the power efficiency of operating servers 3 is higher, is adopted.
Candidate 1: RPS=300 (CPU use rate=40%) is allocated to the third server 3, and RPS=0 (CPU use rate=0%) is allocated to the fourth server 3. In this case, the power efficiency of the third server 3 is 3.8.
Candidate 2: RPS=100 (CPU use rate=20%) is allocated to the third server 3, and RPS=200 (CPU use rate=30%) is allocated to the fourth server 3. In this case, a weighted average by RPSs for two servers is 2.5.
The request distribution part 11 causes (S36) the fourth server 3 (shown by a broken line arrow) to which an RPS is not allocated until S35 to transition to the power saving mode.

FIG. 10 is a table showing processing (S34) of making an update to the table of FIG. 4 regarding the distribution ratio.
As described with reference to FIG. 7, the request distribution part 11 sets (S33; see FIG. 9) the distribution ratio such that an RPS=1000 corresponding to a CPU use rate=80% corresponding to the peak value=8.3 of the power efficiency is allocated to the second server 3. Here, assume that the request distribution part 11 measures a current CPU frequency=2.0 of the first server 3.
Although the RPS corresponding to a CPU use rate=80% at a CPU frequency=2.5 is 1000 in FIG. 4, as the CPU frequency has decreased from 2.5 to 2.0 (decreased to 4/5), the request distribution part 11 also reduces the corresponding RPS from 1000 to 800 (decreases to 4/5).

FIG. 11 is an explanatory diagram showing an example in which the distribution ratio updated in FIG. 10 is applied to the explanatory diagram of FIG. 9.
The RPS of the second server 3 decreases from 1000 to 800, and the remaining RPS=200 is added to the third server 3 (300+200=500). With this, although it takes time to measure the current CPU frequencies of the servers 3, it is possible to calculate an appropriate distribution ratio reflecting the situation of the servers 3.

### Effects

A distribution device 1 of the present invention is characterized in including:
an analysis data storage part 12 that stores, as ratio determination information for determining a distribution ratio for distributing received requests 9 among a plurality of servers 3, a quantity of received requests 9 to be allocated that maximizes the power efficiency, and
a request distribution part 11 that determines, based on the ratio determination information read from the analysis data storage part 12, a distribution ratio for distributing the received requests 9 among the servers 3 such that the quantity of received requests 9 to be allocated that maximizes the power efficiency is assigned to each server 3.

With this, as an appropriate allocation quantity not excessive nor insufficient is assigned from the received requests 9 to each server 3, the distribution device 1 is capable of operating the request processing part 31 of the server 3 so as to increase the power efficiency.
Furthermore, the distribution device 1 is, as compared with the following comparative examples, capable of operating with high power efficiency and operating the distribution logic in a lightweight manner.
In the case of the load balancer described in Non-Patent Literature 1, as distribution such that a specific CPU use rate is maintained cannot be implemented, the server is always caused to operate in a range in which the power efficiency is low and the power consumption required for the processing is increased more than necessary, which is inefficient.
In the case of PEAS described in Non-Patent Literature 2, when the number of RPS is large compared to the frequency at which the resource use rate is updated, even though requests enough to result in the resource use rate maximizing efficiency have already actually been allocated, this situation is not detectable because the resource use rates have not been updated yet, and requests exceeding those resulting in the resource use rate maximizing efficiency may be distributed, resulting in low efficiency. Furthermore, as the distribution destination servers are determined on a per-request basis, the distribution logic has to be executed at a very high frequency, which requires a large overhead. Thus, it is difficult to operate a large amount of requests to be processed by multiple servers with low latency.
PACT, described in Non-Patent Literature 3, is intended to operate a CPU core in a high power consumption range and in a low power consumption range, but fails to take into account the power efficiency in each range, and thus fails to perform operations at an operation point optimal with respect to the resource use rate.

The distribution device 1 of the present invention is characterized in that the request distribution part 11 corrects the quantity of received requests 9 to be allocated that maximizes the power efficiency according to a current operation frequency of each server 3 and determines the distribution ratio for distributing the received requests 9 among the servers 3 based on the corrected quantity of received requests 9 to be allocated.

With this, the distribution device 1 is capable of minimizing the influence of the operating environment of each server 3.

The distribution device 1 of the present invention is characterized in that the request distribution part 11, when determining the distribution ratio for distributing the received requests 9 among the servers 3, causes a server 3 to which no received request 9 is allocated to transition to the power saving mode.

With this, the distribution device 1 is capable of improving the power efficiency of the entire system.

The present invention is a load distribution system 100 including the distribution device 1 and an analysis device 2, characterized in that:
the analysis device 2 includes a data collecting part 21 and a data analysis part 23,
the data collecting part 21, based on the number of requests processed by each server 3 and power consumption required for processing the requests, collects power characteristic information of each server 3, the power characteristic information indicative of power efficiency with respect to the number of requests, and
the data analysis part 23, based on the collected power characteristic information of each server 3, obtains the quantity of received requests 9 to be allocated that maximizes the power efficiency, and causes the analysis data storage part 12 to store the obtained result as the ratio determination information.

With this, the load distribution system 100 is capable of obtaining the ratio determination information with high accuracy by actually measuring the power characteristic information of each server 3. Thus, the accuracy of the distribution ratio for distributing the received requests 9 among the servers 3 is improved.

The load distribution system 100 of the present invention is characterized in that:
the data collecting part 21 classifies the number of requests processed by each server 3 into any of a plurality of request types and collects the power characteristic information of each server 3 for each request type, and
the data analysis part 23, based on the power characteristic information collected per server 3 and per request type, obtains the quantity of received requests 9 to be allocated that maximizes the power efficiency for each request type and causes the analysis data storage part 12 to store the obtained result as the ratio determination information.

With this, the load distribution system 100 is capable of accurately obtaining appropriate power characteristic information of each server 3 according to the request type. Thus, the accuracy of the distribution ratio for distributing the received requests 9 among the servers 3 is improved.

The load distribution system 100 of the present invention is characterized in that:
the data analysis part 23, based on the power characteristic information of each server 3, creates a power efficiency equation indicative of power efficiency with respect to the number of requests, and
the request distribution part 11 determines, for received requests 9 that have remained due to a failure of distributing the quantity of received requests 9 to be allocated that maximizes the power efficiency to any of the servers 3, one or more distribution destination servers 3 such that the power efficiency is increased according to the power efficiency equation.

With this, the load distribution system 100 is capable of distributing even received requests 9 that does not maximize power efficiency in a manner of increasing the power efficiency of the servers 3.

### REFERENCE SIGNS LIST

1 Distribution device (load distribution device)
2 Analysis device
3 Server
9 Received request
11 Request distribution part (distribution part)
12 Analysis data storage part (information storage part)
21 Data collecting part
22 Collected data storage part
23 Data analysis part
31 Request processing part
100 Load distribution system

1-8. (canceled)

9. A load distribution device comprising:
an information storage part including one or more processors and configured to store, as ratio determination information for determining a distribution ratio for distributing a plurality of requests among a plurality of request processing parts, a quantity of requests to be allocated that maximizes power efficiency; and
a distribution part including one or more processors and configured to determine, based on the ratio determination information read from the information storage part, a distribution ratio for distributing the plurality of requests among the plurality of request processing parts such that the quantity of requests to be allocated that maximizes the power efficiency is assigned to each of the plurality of request processing parts.

10. The load distribution device according to claim 9,
wherein the distribution part is further configured to, for each of the plurality of request processing parts, correct the quantity of requests to be allocated that maximizes the power efficiency according to a current operation frequency of the request processing part and to determine a quantity of requests to be allocated to the request processing part based on the corrected quantity of requests to be allocated that maximizes the power efficiency.

11. The load distribution device according to claim 9,
wherein the distribution part, when determining the distribution ratio for distributing the plurality of requests among the plurality of request processing parts, causes, of the plurality of request processing parts, a request processing part to which none of the plurality of requests is allocated to transition to a power saving mode.

12. A load distribution system comprising: the load distribution device according to claim 9; and an analysis device,
wherein the analysis device comprises a data collecting part and a data analysis part,
wherein the data collecting part includes one or more processors and is configured to, for each of the plurality of request processing parts, based on a number of requests processed by the request processing part and power consumption required for processing the requests processed by the request processing part, collect power characteristic information of the request processing part, the power characteristic information indicative of power efficiency with respect to the number of requests, and
wherein the data analysis part includes one or more processors and is configured to, for each of the plurality of request processing parts, based on the collected power characteristic information of the request processing part, obtains the quantity of requests to be allocated that maximizes the power efficiency, and causes the information storage part to store the obtained quantity of requests to be allocated that maximizes the power efficiency as part of the ratio determination information.

13. The load distribution system according to claim 12,
wherein the data collecting part is further configured to, for each of the plurality of request processing parts, classify the requests processed by the request processing part into a plurality of request types and to collect the power characteristic information of the request processing part for each request type, and
wherein the data analysis part is further configured to, based on the power characteristic information collected per request processing part and per request type, obtain the quantity of requests to be allocated that maximizes the power efficiency for each request type and to cause the information storage part to store the obtained quantity of requests to be allocated that maximizes the power efficiency for each request type as part of the ratio determination information.

14. The load distribution system according to claim 12,
wherein the data analysis part is further configured to, for each of the plurality of request processing parts, based on the power characteristic information of, create a power efficiency equation indicative of the power efficiency with respect to the number of requests processed by the request processing part, and
wherein the distribution part is further configured to determine, for remaining requests that have remained due to a failure of distributing the quantity of requests to be allocated that maximizes the power efficiency to any of the plurality of request processing parts, one or more of the plurality of request processing parts as destinations to which the remaining requests are to be distributed such that, for each of the one or more of the plurality of request processing parts, the power efficiency is increased according to the power efficiency equation of the request processing part.

15. A load distribution method to be executed by a load distribution device including an information storage part and a distribution part, the distribution part including one or more processors, the information storage part including one or more processors and configured to store, as ratio determination information for determining a distribution ratio for distributing a plurality of requests among a plurality of request processing parts, a quantity of requests to be allocated that maximizes power efficiency, the load distribution method comprising a step of:
determining, by the distribution part, based on the ratio determination information read from the information storage part, a distribution ratio for distributing the plurality of requests among the plurality of request processing parts such that the quantity of requests to be allocated that maximizes the power efficiency is assigned to each of the plurality of request processing parts.

16. A non-transitory computer-readable medium storing a computer program for causing a computer to function as the load distribution device according to claim 1.
